(19) United States
(12) Patent Application Publication
(10) Pub. No.: US 2026/0084341 A1
(43) Pub. Date: Mar. 26, 2026

(54) APPARATUS AND METHOD FOR CONTINUOUSLY CASTING A MEMBER FROM A SETTABLE MATERIAL

(71) Applicants: Joseph NORRIS, Townsville (AU); Roderick MCDONALD, Sheldon (AU)

(72) Inventors: Joseph NORRIS, Townsville (AU); Roderick MCDONALD, Sheldon (AU)

(21) Appl. No.: 19/405,021

(22) Filed: Dec. 1, 2025

Related U.S. Application Data
(63) Continuation-in-part of application No. 18/007,069, now abandoned.

(30) Foreign Application Priority Data
Jul. 29, 2020 (AU) 2020902663

(51) Int. Cl. B28B 5/02; B28B 23/02

(52) U.S. Cl. CPC B28B 5/027; B28B 23/02

(57) ABSTRACT

An apparatus for continuously casting a solid member is disclosed. The apparatus may include a mould forming support configured to form an open channel, a flexible conveyor having a feed end and a peel off end extending across the mould forming support along its length. The conveyor conforms to the configuration of the mould forming support along its length to form an open channel mould which receives a settable material that is displaced along the conveyor belt and forms a solid member. A method of continuously casting a solid member is also disclosed.

### CROSS REFERENCE TO RELATED APPLICATIONS

This application is a continuation in part of U.S. Ser. No. 18/007,069 filed Jan. 27, 2023, which is a national stage filing of PCT/AU2021/050828 filed Jul. 29, 2021, both of which are incorporated herein by reference.

### FIELD

This invention relates to an apparatus for continuously casting a member from a settable material. The invention extends to a method for continuously casting a member from a settable material.

The invention relates particularly but not exclusively to an apparatus for continuously casting a member, e.g. of constant cross section along its length, from a settable cementitious material such as concrete and it will be convenient to hereinafter describe the invention with reference to this example application. The invention is particularly useful for continuously casting concrete sleepers for use in retaining walls. However, it is to be clearly understood that the invention is capable of broader application. For example, the invention could be used to continuously cast railway sleepers, posts and other articles.

### BACKGROUND

Cementitious members are typically cast from a settable cementitious material that is in the form of a slurry. The material typically has a relatively high viscosity, but it still has ability to flow.

Cast cementitious members may be used to make many different cementitious or concrete products including but not limited to the following:
Retaining wall sleepers;
Wall panels;
Railway sleepers; and
Landscaping products.

In the prior art, such cast concrete products have typically been made by a batch casting process. That is, the individual products are made by pouring a slurry material into a discrete batch mould where the cementitious slurry is caused to cure. A batch mould is static in the sense that it simply retains the settable material and does not move during the moulding process. After the concrete material has cured, the products are broken out of the mould and handled for subsequent distribution and use.

The discrete individual batch moulds are of fixed size and are customised to match the configuration of the product to be cast. That is, a single static mould is used to cast a single product and the material is retained in the mould until it has set.

Relevantly, prior art batch processes for manufacturing cementitious products in individual moulds have many shortcomings, some of which are set out below.

Batch manufacture is a labour-intensive process which requires personnel to physically undertake or contribute to each step in the process. It also has a relatively high rate of products that do not meet the product specifications and need to be rejected.

In many existing systems, the moulds are transported via forklift (occasionally via roller conveyor) around the factory from one step to the next. The moulds are typically manually filled by personnel who fit the internal reinforcing materials then pour slurry material. The moulds are then transported by forklift from the feeding location to a curing chamber into which the moulds are placed for curing the concrete in the moulds. Typically, the curing chamber is a large room into which steam is pumped for heating and curing the concrete.

At the end of the curing process, forklift trucks are typically once again used to lift the moulds up and transport them out of the curing chamber to another location where the formed concrete products are broken out or knocked out of the moulds. By saying the product must be ‘knocked-out’ of the mould is meant the surface of the product must be detached from the surface of the mould and to do this the mould is inverted and occasionally knocked.

In the prior art batch systems, the cast concrete must be sufficiently hardened before it is broken out from the mould. The existing knocking out process requires a fully set product before it can be broken out of the mould. This is currently achieved with a cure time of at least three to four hours for the product to achieve sufficient structural capacity to withstand the forces involved in the knock-out process. Full curing would typically take about 28 days.

The ‘knocking-out’ process for product ejection from the mould can result in a high incidence of product damage which increases the costs of manufacture (and reduces productivity) and it also adversely affects the consistency of the quality of the product.

A further reason for the extensive curing that is required is that the cast concrete products produced by the process must also have the mechanical strength when removed from the mould to withstand the forces involved in general handling and stockpiling of the cast product, although these forces are typically less those associated with knock out.

Additionally, in prior art batch processes, additives may be added to the mixture to increase the speed of curing or secondary processes to reduce curing time. This adds to the cost and additionally labour is required to mix the additives into the concrete mixture.

Further, the moulds are typically required to be sprayed early in the process with a mould release agent (to lower the bond between the concrete and the mould). With a high reliance on a release agent to facilitate the knocking out process, if the mould is not sufficiently covered in release agent at the start, part of the cast product can bond with the mould and break off at ‘knock out’ or alternatively damage the mould as it pulls away from the mould.

Yet further, the surface of the completed product can be contaminated with the release agent which can pick up grit and dust (which increases wear on the mould) and the ejected product can require cleaning to remove residual release agent after it has been removed from the mould.

In addition to the shortcomings discussed above, Applicant also makes the following comments about prior art techniques.

Prior art systems typically have high maintenance costs, particularly for mould replacements. The moulds need to be replaced relatively frequently and this replacement incurs a substantial cost.

Further, given the in-mould curing time required, a significant number of moulds need to be commissioned and used to enable manufacture of cast concrete products on a commercial scale. In some case, to increase rate of production, the number of moulds used can be a multiple of the daily expected production, e.g. 2 times the required daily production. A significant capital investment is therefore required to establish a commercial scale plant for producing cast concrete members.

Another noteworthy feature of the prior art batch technique for producing concrete products is that the rigid batch moulds generally require a taper on the walls to facilitate separation of the cast product from the mould after curing. If the walls are orthogonal to a base or floor of the mould, then it is not practical to remove the product from the mould. Consequently, in prior art batch techniques, the fill height in the mould is critical as a change in thickness of 5 mm will result in a change in the width of the cast product (product width is a function of height). Even a change of 1 mm in a product width can result in a product stack height being uneven.

Parallel sided members can still be produced, but mould complexity increases for parallel sides because the sides of the moulds need to be removed to extract the sleeper. This adds complexity to the mould and is also very time consuming. Further, prior art systems require extensive operator involvement and are labour intensive and this increases hazards to personnel, increases risks to the quality of the product and often leads to equipment/product damage.

Thus, prior art batch systems separate the different unit operations and require transport between process stations which increases risks to personnel, product and plant. Further, the prior art systems require extensive operator involvement and are labour intensive and this leads to manufacturing inefficiencies with higher costs and increased waste.

The reference to prior art in the background above is not and should not be taken as an acknowledgement or any form of suggestion that the referenced prior art forms part of the common general knowledge worldwide or in any particular country or jurisdiction.

### SUMMARY OF THE DISCLOSURE

Applicant has recognised that prior art methods and apparatus for casting concrete products have significant limitations. Approaches to process improvement and development have not addressed the limitations of the original process, such as rigid and individual moulds which require transportation around the factory, the introduction of release agents into the mould to assist with knock out, and the knock out to eject the product and associated damage to moulds requiring replacement.

Rather, prior art batch processes have generally sought to automate discrete and individual steps of the prior art manufacture of cast concrete products. Typically, processes have sought to replace manual human actions with automated machine actions of the same discrete tasks.

Applicant recognizes that a fundamentally new and different approach is desirable to overcome or at least ameliorate limitations of the batch production of cementitious members. Accordingly, at least certain embodiments of the present invention can at least partially ameliorate one or more limitations of prior art processes, such as those limitations described hereinabove. Without limitation, embodiments of the present invention are generally directed to new continuous casting approaches, rather than improvements of prior art batch processes by automation of discrete steps.

According to an aspect there is provided a method for continuously casting a solid concrete member from a settable cementitious material that forms concrete when cured, comprising:

providing a conveyor having a feed end and a peel off end, the conveyor comprising a flexible conveyor belt that is displaced in a conveying direction from the feed end to the peel off end, deforming the conveyor belt so that it is configured in the form of an open channel mold near the feed end and travels in the conveying direction, the open channel mold comprising substantially vertical side walls and a substantially horizontal bottom wall, feeding the settable cementitious material into the open channel mold and displacing the settable cementitious material along the conveyor to the peel off end, curing the settable cementitious material during displacement along the conveyor so that the cementitious material forms at least part of an elongate solid concrete member before it reaches the peel off end, separating the formed solid concrete member from the open channel mould by deforming the conveyor belt from the open channel mold to separate the vertical side walls from the solid member and changing the angle or orientation of the conveyor belt at the peel off end to separate the bottom wall from the solid member.

The solid concrete member may be a structural concrete member.

Deforming the conveyor belt from the open channel mold to separate the vertical side walls from the solid member may comprise forming the conveyor belt into a substantially flat configuration.

Changing the angle or orientation of the conveyor belt at the peel off end to separate the bottom wall from the solid member may comprise changing the direction of the conveyor belt.

The conveyor may comprise a return roller at the peel off end and said changing the direction of the conveyor belt at the peel off end may comprise passing the conveyor belt over the return roller. The conveyor belt may undergo a change in direction of about 180 degrees.

Thus, the conveyor belt may peel away from the solid concrete member as it approaches the return roller and this gentle process reduces breakage of the cast solid concrete members when they are separated from the conveyor belt.

The open channel mould may be formed with a substantially constant cross-sectional configuration along its length.

Said curing may comprise heating the settable cementitious material while it is being displaced along the conveyor towards the peel off end.

Said heating may comprise one or more of: radiation heating, convection heating, and conductive heating.

Said heating may comprise passing the conveyor through a tunnel and heating the settable cementitious material while it is passing through the tunnel.

Said heating may comprise radiating the settable cementitious material with radiant heaters within the tunnel.

Said heating may comprise convection heating the settable cementitious material with hot air or steam within the tunnel.

Said curing may comprise chemically curing the settable cementitious material while it is being displaced along the conveyor.

Said chemical curing of the settable cementitious material may comprise curing with calcium aluminate.

For example, the settable cementitious material may comprise 10-20 weight % of calcium aluminate. The calcium aluminate within the cementitious material may help to speed up and expedite curing of the settable cementitious material.

Said curing may comprise heating said settable cementitious material in addition to chemically curing said cementitious material. For example, the settable cementitious material may be heated to a temperature of at least 40 degrees Celsius, e.g. at least 52 degrees Celsius and up to 70 Degrees Celsius. In particular, heating a cementitious material as described that contains calcium aluminate has been found to expedite curing of the cementitious material.

Further or instead, said curing may comprise chemically curing the settable cementitious material with siliceous or silico-aluminous materials.

The method may further comprise dividing the settable cementitious material on the conveyor into discrete elements on the conveyor to form separate solid concrete members by at least one of: lowering dividers into the settable cementitious material before it cures; and placing dividers upstream of a position where the settable cementitious material is fed into the open channel mould to divide the open channel mould into lengthwise sections.

The method may further comprise inserting a reinforcing member into the settable cementitious material in the open channel mould before it cures whereby to provide reinforcing in the solid concrete member.

The method may comprise configuring the solid concrete member to form a concrete sleeper having a substantially rectangular cross-sectional configuration.

The method may include any features, or combinations of features, of the method defined in any other statement in the summary section.

According to another aspect there is provided an apparatus for casting a solid concrete member from a settable cementitious material that cured to form concrete, the apparatus comprising:
a conveyor having a feed end and a peel off end, the conveyor comprising a flexible conveyor belt that is displaced in a conveying direction from the feed end to the peel off end; and
a feeder for feeding a flowable settable material onto the conveyor,
wherein the conveyor belt is deformed into a main casting section forming an open channel mould of substantially constant cross sectional configuration with substantially vertical side walls and a substantially horizontal bottom wall, and the conveyor belt is formed into a peel off transition section towards the peel off end which is different from the open channel mould to separate the conveyor belt from a solid concrete member formed on the conveyor.

The peel off transition section may the conveyor belt into a substantially flattened configuration to separate the vertical side walls of the open channel mould from a formed solid concrete member.

The conveyor may comprise a return roller at the peel off end and the belt may be bent around the return roller to separate the bottom wall of the open channel mould from a formed solid concrete member.

The apparatus may include at least one heater for heating the settable material within the open channel mould for curing the settable material to form the solid member. The at least one heater may comprise at least one heater type selected from the following is selected from the group comprising: one or more radiant heaters; one or more conductive heaters; and/or one or more convection heaters displacing steam or hot air over the settable material in the open channel mould.

The apparatus may comprise a feed transition section towards the feed end which transitions the conveyor belt into the main casting section.

The feeder may be configured to feed a flowable settable material onto the conveyer comprising a mixing unit for drawing components from separate tanks and mixing the to form the settable cementitious material in the form of a flowable slurry.

The apparatus may comprise a height setter comprising a height setting member positioned downstream of the feeder that enables the height of the settable material in the open channel mould to be adjusted whereby to set the thickness of the solid concrete member produced by the open channel mould.

The apparatus may comprise a product divider inserter for inserting a divider into the settable material fed onto the conveyor to divide it into discrete solid members.

The apparatus may comprise a reinforcing inserter for inserting a reinforcing element into the settable material to provide reinforcing in the formed solid member.

The apparatus may include any features, or combinations of features, of the apparatus defined in any other statement in the summary section.

In an embodiment, the invention provides an apparatus or system for casting a solid member, comprising:
a mould forming support configured to form an open channel; and
a flexible conveyor extending across the mould forming support and bending into the configuration of the mould forming support to form an open channel mould,
wherein the open channel mould receives a settable material which is cured as it is displaced along the conveyor to form a cast solid member.

The mould forming support of the apparatus or system of the embodiment may transition into a flat section downstream of the open channel to flatten the flexible conveyor to facilitate separation of the cast solid member from the conveyer.

According to a second embodiment, there is provided an apparatus or system for casting a solid member, the comprising:
a mould forming support configured to form an open channel; and
a flexible conveyor having a feed end and a peel off end extending across the mould forming support along its length and conforming to the configuration of the mould forming support along its length to form an open channel mould, the open channel mould receiving a settable material which is displaced along the conveyor and forms a solid member, wherein
the mould forming support and the conveyor transition to a flat configuration downstream of the open channel mould to facilitate separation of the solid member that is cast in the open channel mould.

According to a third embodiment, there is provided an apparatus or system for casting a solid member, comprising:
a mould forming support configured to form an open channel mould; and
a conveyor having a feed end and a peel off end extending along the mould forming support in contact with the mould forming support such that the conveyor assumes a configuration that is complementary to the mould forming support, wherein
the mould forming support has an open channel that deforms the conveyor into an open channel mould along part of its length, for receiving a settable material which is cast into a solid member as it is conveyed from the feed end to the peel off end, and
wherein the open channel of the mould forming support transitions into a flat support so that the open channel mould formed by the conveyer transitions into a flat configuration which facilitates separation of the cast solid product from the conveyer.

The apparatus or system of the third embodiment may have a return roller at the peel off end around which the conveyer turns which further assists in separating the solid product from the conveyor.

The apparatus or system according to embodiments as described herein can function to continuously cast solid members from a settable material, e.g. a settable cementitious material, that may deform the conveyor to form an open channel mould in which the member is cast as the conveyor moves along its path. The apparatus or system can also function to separate the cast solid member from the open channel mould once the solid member has been cast. Further, the apparatus can facilitate this important task of separating the cast solid product from the mould automatically as part of the operation of the conveyor belt without any, or any substantial, manual or operator involvement.

Suitably, the conveyer according to the apparatus or system as described herein is or comprises a conveyer belt or the like.

The conveyor according to the apparatus or system as described herein may comprise an endless belt conveyor having a casting leg extending from the feed end to the peel off end; a roller at the peel off end around which the belt turns; and a return leg extending underneath the casting leg from the peel off end back to the feed end. Thus, the cast solid member can separate from the conveyor belt when the conveyor belt flattens and then turns around the roller at the peel off end.

The settable material as described herein may be a cementitious material, e.g. concrete. Suitably, the settable material may be cured by being exposed to heating after it has been fed onto the conveyor belt.

The formed solid product as described herein may be a cementitious product that has been cured sufficiently to enable it to be handled separately from the conveyor belt on which it is carried without breaking.

Suitably, the mould forming support of apparatus and systems of the embodiments described herein is stationary and in the form of an open channel which extends a substantial length of the conveyor between the feed end and the peel off end. Suitably, the mould forming support has an operatively upper surface and the conveyor is displaced over the surface of the mould forming support.

The mould forming support may include a main casting section that is of substantially constant cross section along a substantial part of its length.

The mould forming support may have a feed transition section which transitions from a substantially flat surface into the main casting section forming the upwardly opening channel.

The mould forming support may have a peel off transition section which transitions from an upwardly open channel back into a substantially flat surface.

The apparatus or system may include a sliding arrangement to ease movement of the conveyor or belt thereof belt over the operatively upper surface of the mould forming support.

The sliding arrangement may utilise pneumatic pressure to reduce the effective weight of the conveyer and settable material bearing on the mould forming support to make it easier for the conveyer to slide across the mould forming support.

The sliding arrangement may facilitate injecting air under pressure into a space between the operatively upper surface of the mould forming support and the conveyor and thereby provide some lift to the conveyor to reduce the effective weight of the conveyor and settable material on the mould forming support.

The apparatus or system may include a feed arrangement for feeding a flowable settable material onto the conveyer. Suitably, the feed arrangement is for feeding flowable settable material onto the conveyer.

The feed arrangement may comprise a mixing unit. The mixing unit may draw various components from separate tanks and mixing them together to form a flowable settable material, e.g. a settable cementitious mix in slurry form.

The feed arrangement may comprise a vibrating hopper for encouraging the settable material to flow through the hopper and onto the conveyor.

Suitably, the feed arrangement is located between the feed end and the peel off end of the conveyer. In embodiments, the feed arrangement is located towards the feed end. In embodiment, the feed arrangement is located proximate the feed end.

The conveyer may comprise a lead up portion extending between the feed end and the feed arrangement. The lead up portion may be an elongated lead up portion.

The apparatus or system may include a product divider insertion arrangement for dividing settable material on the conveyer. The product divider insertion arrangement may comprise a divider structure.

In embodiments, the divider structure is positioned or positionable upstream of the feed arrangement. Suitably, settable material can be poured onto, into, or through the divider structure, so as to form an interruption or break in the settable material being displaced along the conveyer, to form separate cast solid members.

In embodiments, the divider structure is positioned or positionable downstream of the feed arrangement. Suitably, settable material can be poured onto, into, or through the divider structure, so as to form an interruption or break in the settable material being displaced along the conveyor, to form separate cast solid members.

The apparatus or system of embodiments described herein may further include a reinforcing insertion arrangement.

In embodiments, the reinforcing insertion arrangement is located upstream of the feed arrangement. In embodiments, the reinforcing insertion arrangement is located downstream of the feed arrangement.

The reinforcing insertion arrangement may comprise a structure that grabs a reinforcing member, e.g. a steel reinforcing member, and positions the reinforcing member relative to the conveyer.

In embodiments, the reinforcing insertion arrangement positions the reinforcing member upstream of the feed arrangement. In embodiments, the reinforcing insertion arrangement positions the reinforcing member downstream of the feed arrangement.

The reinforcing insertion arrangement may include a gantry and a lowering arm that lowers the reinforcing member towards the conveyer. In embodiments, the lowering arm may lower the reinforcing member into the settable material such that the reinforcing member is fully received within the settable material.

The apparatus or system may include at least one heating arrangement, or a plurality of heating arrangements for heating the settable material within the open channel mould for curing the settable material to form the solid member.

The heating arrangement(s) may include one or more or a plurality of radiant heaters, e.g. microwave heaters for radiating energy onto the settable material in the open channel mould.

The heating arrangement(s) may further include one or more or a plurality of conductive heaters for heating the settable cementitious material, such as through the wall of the conveyor.

The radiant heaters and the conductive heaters may be mounted along a part of the length of the conveyor and/or along the length of a tunnel structure over the conveyer such as hereinbelow described. The apparatus or system may include radiant and/or microwave heating systems extending along at least a portion of the conveyor.

The heating arrangement(s) may further include one or more or a plurality of arrangements heating by displacing steam or hot air over the settable material in the open channel mould.

The apparatus or system may further include a tunnel structure at least partly enclosing the conveyor for use in facilitating curing of the settable material. The tunnel structure may confine steam and direct it over an upper surface of the settable material within the open channel mould.

Advantageously, the settable material may be heated to a temperature of about 60 degrees Celsius (60° C.) to expedite curing of the settable material.

The apparatus or system may include a height setting arrangement for setting the height of the settable material in the open channel mould. The height setting arrangement may be of the feed arrangement.

The height setting arrangement may be adjustable to enable the height of the settable material fed into the open channel mould to be adjusted. It will be appreciated that this height will determine the thickness of the cast solid member produced by the apparatus involves the use of a depth setting member which involves the use of static head and friction of the slurry.

The apparatus or system may include a further conveyor downstream of the peel off end for curing or further curing of the formed solid members.

The further conveyor may comprise a series of spaced rollers extending transversely to the direction of travel of the solid members for conveying the members along a path that enables the solid members to be cured to facilitate strengthening before the solid members are taken off the production line.

The further conveyor may facilitate further curing of the formed solid members before they are removed for general handling and stacking, e.g. on pallets or the like.

Suitably, the further conveyer comprises a further conveyer belt or the like.

The apparatus or system may include a solid member handling arrangement for removing the solid cast members from the production line as they are formed and then placing them in or on a storage or distribution member such as a pallet.

The apparatus or system of embodiments as described herein may include a surface finishing arrangement for impressing a surface appearance on the solid member. Suitably, the surface finishing arrangement impresses the surface appearance into the settable material before the settable material is set and/or cured.

The surface finishing arrangement may include a stamp for stamping a pattern or appearance into an open and upwardly facing surface of the settable material.

The stamp may be positioned above the conveyor and may be displaced downwardly into contact with the upper surface of the settable material within the open channel mould.

According to a fourth embodiment of the invention, there is provided an apparatus or system for casting a solid member, comprising:
a mould forming support configured to form an open channel;
an endless flexible conveyor having a feed end and a peel off end, with a casting leg extending from the feed end to the peel off end and then returning along a return leg underneath the casting leg;
a mould forming support positioned beneath the casting leg of the conveyor such that the configuration of the mould forming support bends the conveyor travelling across it into a complementary configuration to the support, wherein
the mould forming support includes a casting section in the form of an open channel and a peel off section in which it transitions from the open channel into a flat section, and
wherein the conveyer forms an open channel mould when travelling across the casting section of the mould forming support and transitions into a flat configuration across the peel off section of the mould forming support for facilitating separation of a solid member from the open channel mould in which it is cast.

The apparatus or system of the fourth embodiment may include a feed roller at the feed end around which the conveyer turns when moving from the return leg to the casting leg and a return roller around which the conveyer turns when moving from the casting leg to the return leg, and the direction of the conveyer changes when it turns around the return roller and this further facilitates separation of the cast solid product from the conveyor.

The mould forming support as described herein may have an operatively upper surface that contacts the conveyer travelling across it, and the operatively upper surface may be smooth to assist the conveyor in moving across the mould forming support.

The conveyor or further conveyer as described herein may comprise low friction flexible sheet material to assist the conveyor or belt thereof in moving across e.g. the mould forming support.

The mould forming support may further include a feed transition section in which it transitions from a flat member to the open channel mould, wherein the conveyer has a feed transition section complementing the mould forming support.

The open channel of the casting section as described herein may suitably have side walls extending up from a base. In the peel off section the side walls may taper outwards along the length of the peel off section until the side walls are flat and lie in plane with the base.

The feed transition section of the mould forming support may have a similar shape and configuration to the peel off transition section, with an exception that the feed transition section starts as flat at the feed roller and then transitions in the open channel of the casting section.

The open channel of the casting section may have side walls extending up from a base and in the peel off section the side walls may taper outwards along the length of the peel off section until the side walls are flat and lie in plane with the base.

According to a fifth embodiment of the invention, there is provided a method for casting a solid member from a settable material, the method comprising:
deforming a conveyor into an open channel mould; and
feeding a settable material into the open channel mould and allowing the settable material to cure as it is displaced by the conveyor.

According to a sixth embodiment of the invention, there is provided a method for casting a solid member from a settable material, comprising:
deforming a conveyor having a feed end and a peel off end into an open channel mould;
feeding a settable material onto the conveyor near the feed end so that it fills the open channel mould and allowing the settable material to cure and form a solid member as it is displaced by the conveyor towards the peel off end; and
deforming the conveyor from the open channel mould into a substantially flat configuration to facilitate separation of the solid member from the conveyor.

The method of the sixth embodiment may include changing the direction of the conveyor at the peel off end to further assist separating the solid member from the conveyor.

The conveyer may include a return roller at the peel off end thereof, and changing the direction of the conveyor at the peel off end may include passing the conveyor over the return roller where it undergoes a change in direction of about 180 degrees.

Suitably, the conveyer peels away from the cast product as it approaches the return roller head drum, and this relatively gentle process can enable the solid member to be safely separated from the mould without breakage even if it is not fully cured. Thus, the method of one or more embodiments described herein need not require ‘knock out’ using a forceful thumping blow to separate the member from the batch mould.

According to a seventh embodiment of the invention, there is provided a method for casting a solid member from a settable material, comprising:
passing a conveyor having a feed end and a peel off end over a mould forming support which bends the conveyor into the form of an open channel mould;
feeding a settable material onto the conveyor near the feed end so that it fills the open channel mould and allowing the settable material to cure and form a solid member as it is displaced by the conveyor towards the peel off end; and
transitioning the deformed conveyor forming the open channel mould into a substantially flat configuration prior to the peel off end to facilitate separation of the solid member from the conveyor.

The method of the seventh embodiment may include changing the direction of the conveyor at the peel off end to further assist separating the solid member from the conveyor.

Suitably, according to the method of the fifth to seventh embodiments as described herein, the settable material is continuously or substantially continuously fed onto the conveyer. The settable material may be continuously or substantially continuously fed into the open channel mould. The settable material may be continuously or substantially continuously fed at a location towards or proximate the feed end of the conveyer.

Suitably, the apparatus or system of the first to fourth embodiments as described herein is adapted for use in continuous casting or a continuous casting process of the solid member, as herein defined.

Suitably, the method of the fifth to seventh embodiments as described herein is a continuous casting or continuous casting process of the solid member, as herein defined.

It will be understood that any of the first to seventh embodiments of the invention may include, as applicable, the same or corresponding features as any one or more of the features, inclusive of optional or preferred features, defined or described in other embodiments of the invention disclosed herein.

### BRIEF DESCRIPTION OF THE DRAWINGS

An apparatus, system, and/or method for continuously casting a settable cementitious material to produce a solid member in accordance with the invention may be achieved in a variety of forms. It will be convenient to hereinafter describe in detail embodiments of the invention with reference to accompanying drawings. The purpose of providing this detailed description is to instruct persons having an interest in the subject matter of the invention how to carry the invention into practical effect. However, it is to be clearly understood that the specific nature of this detailed description does not supersede the generality of the preceding summary section. The Detailed Description will make reference to the accompanying drawings, by way of example, in which:

FIG. 1 is a schematic side view of an embodiment of an apparatus for casting a member from a settable cementitious material;

FIG. 2 is a perspective view of an end of the apparatus shown in FIG. 1;

FIG. 3 is a cross sectional view of the apparatus shown in FIG. 1 with the section taken towards an inlet or feed end;

FIG. 4 is an upper perspective view of a section of the apparatus of FIG. 1 showing a feed arrangement and a reinforcing insertion arrangement;

FIG. 5 is an upper perspective view of another section of the apparatus of FIG. 1 showing heating arrangements for heating the settable cementitious material, the heating arrangements being located along the conveyor belt to cure the settable cementitious material;

FIG. 6 is an upper perspective view of another section of the apparatus of FIG. 1 showing a surface finishing arrangement for stamping an impression on a surface of the cast member;

FIG. 7 is an upper perspective view of another section of the apparatus of FIG. 1 showing a tunnel structure for heating the cast member.

FIG. 8 is an upper side perspective view of an end section of the apparatus of FIG. 1 showing how the conveyor belt peels off the formed cementitious member;

FIG. 9 is an upper end perspective view of the peel off shown in FIG. 8;

FIG. 10 is an upper perspective view of two cast members producible by the apparatus shown in FIG. 1 or a similar apparatus;

FIG. 11 is an upper perspective view of a different cast member producible by the apparatus shown in FIG. 1 or a similar apparatus;

FIG. 12 is an upper perspective view of a yet further cast member that is in the form of a post producible by the apparatus shown in FIG. 1 or a similar apparatus; and

FIG. 13 is an upper perspective view of a yet further cast member that is in the form of a flat panel producible by the apparatus shown in FIG. 1 or a similar apparatus.

FIG. 14 is a schematic partial side view of another embodiment of an apparatus for casting a member from a settable cementitious material;

FIG. 15 is a schematic partial side view of another embodiment of an apparatus for casting a member from a settable cementitious material.

### DETAILED DESCRIPTION OF EMBODIMENTS

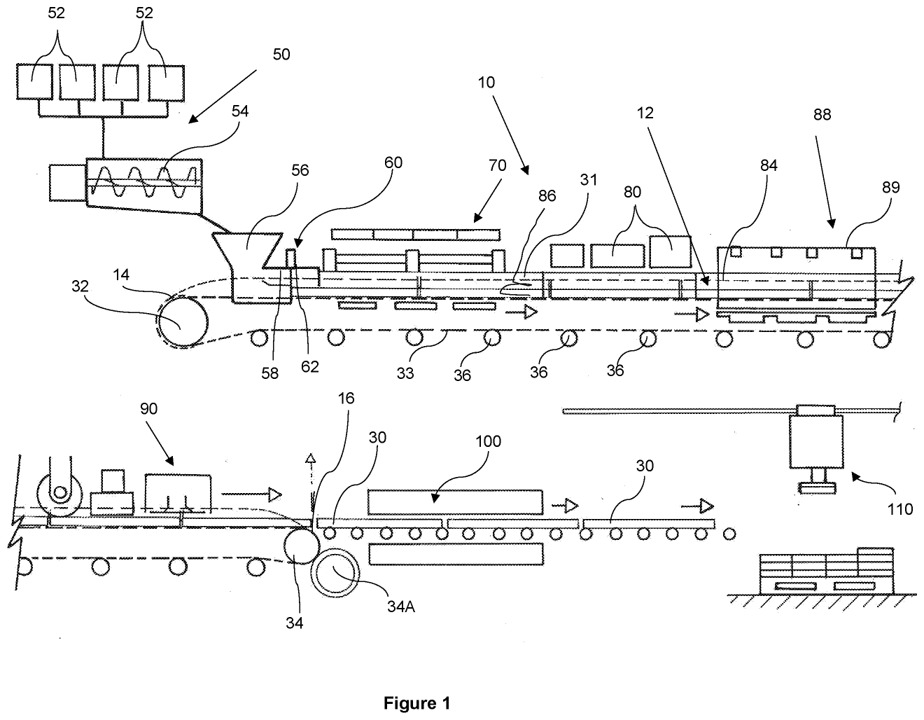

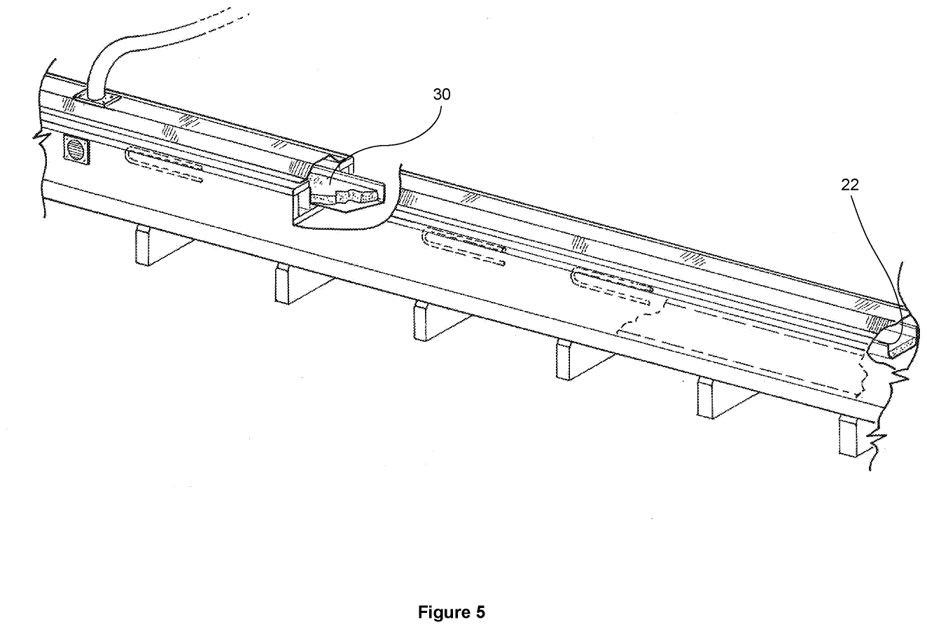

FIGS. 1 to 9 and serve to illustrate a typical embodiment of an apparatus or system and method or process for continuously casting a solid member from a settable material. In FIG. 1, reference numeral 10 refers generally to the apparatus for continuously casting the solid members.

The apparatus 10 comprises a flexible conveyor belt 12 having a feed end 14 and a peel off end 16; and a mould forming support 20. The mould forming support 20 is configured to form an open channel extending a large part of the length from the feed end 14 to the peel off end 16 of the conveyer belt 12. The flexible conveyor belt 12 runs over the mould forming support 20 which bends the belt into the open channel configuration of the mould forming support 20 so as to form an open channel mould 22. The mould 22 receives the settable material which is then conveyed in the mould from the feed end 14 to the peel off end 16. The settable material is cured in the open channel mould 22 to form a cast solid member 30 as it is conveyed from the feed end 14 to the peel off end 16. The conveyor belt 12 transitions from the open channel mould 22 to a substantially flat belt 24 just prior to the peel off end 16 and the cast solid member 30 separates from the conveyor belt 12 as this occurs.

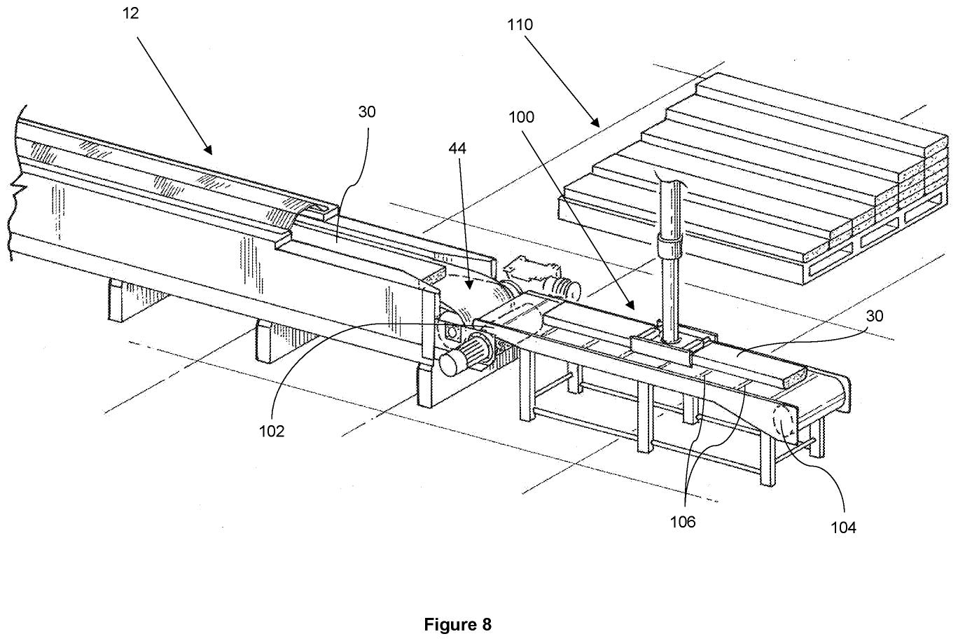

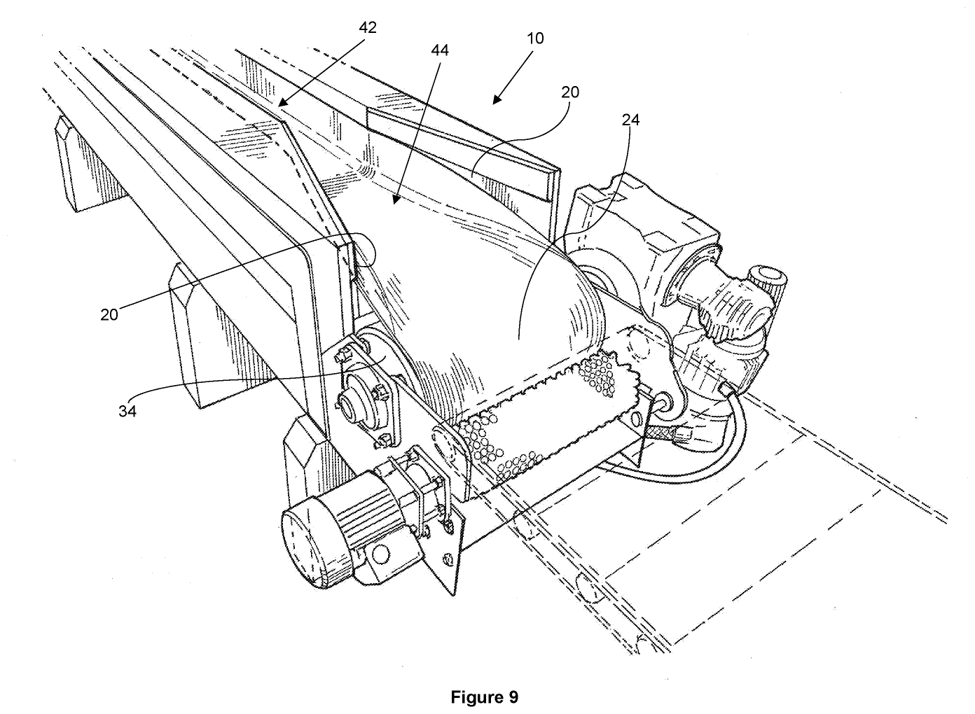

The belt configuration complements that of the mould forming support across which it travels and thus transitions to a flat belt in correspondence to the mould forming support. This is shown in some detail in FIGS. 8 and 9.

The settable material may be a cementitious material, e.g. concrete, and the settable cementitious material may be cured by exposing it to heat after it has been fed onto the conveyor belt 12. The formed cast solid member 30 or solid product will thus be a cementitious product, e.g. a concrete panel, that has been cured sufficiently to enable it to be handled separately apart from the conveyor belt 12 on which it is carried without it being broken.

The conveyor belt 12 comprises an endless belt conveyor having a casting leg 31 extending from the feed end 14 to the peel off end 16 and a return leg 33 extending underneath the casting leg 31 from the peel off end 16 to the feed end 12. This is best shown in FIG. 1. The endless belt 12 passes around respectively a feed roller 32 at the feed end 14 of the belt 12 and a return roller 34 at the peel off end 16 of the belt 12. The conveyor belt 12 also includes a plurality of support rollers 36 supporting the return leg 33 of the conveyor 12 at spaced intervals along the return leg 33. The cast solid product 30 completely separates from the belt conveyor 12 when the belt 12 turns around the return roller 34 at the peel off end 16 and returns to the feed end 14 on the return leg 33.

The mould forming support 20 extends substantially the full length of the conveyor 12 between the feed end 14 and the peel off end 16. Again, this is best shown in FIG. 1.

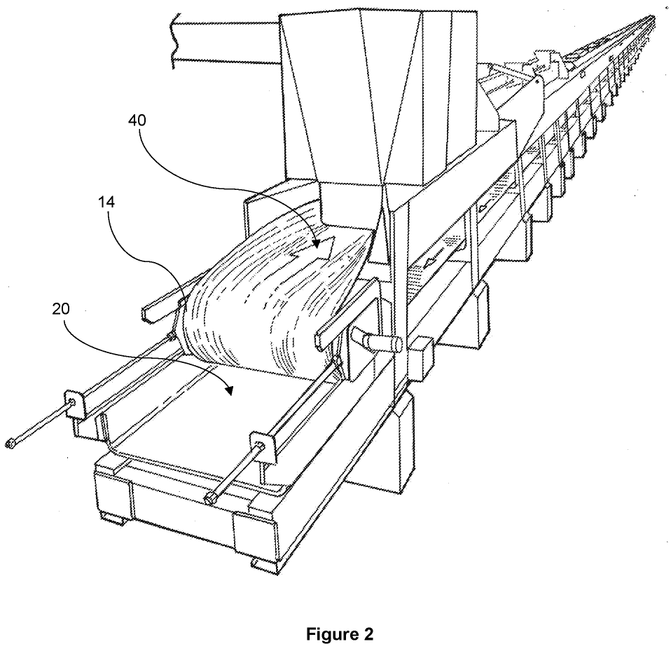

The mould forming support 20 comprises a feed transition section 40 towards the feed end 14 of the conveyor 12, a main mould forming section 42 and a peel off transition section 44 towards the peel off end 16 of the conveyor 12. The feed transition section 40 transitions from a substantially flat upper surface into an upwardly open channel which transitions the flexible belt from a substantially flat surface into the open channel mould 22. This is clearly shown in FIG. 2. The main mould forming section 42 is of a substantially constant cross section along its length. In turn, the open channel of the main mould forming section 42 transitions to the peel off transition section 44 which has a substantially flat surface which flattens the belt out prior to it passing around the return roller 34 at the peel off end 16.

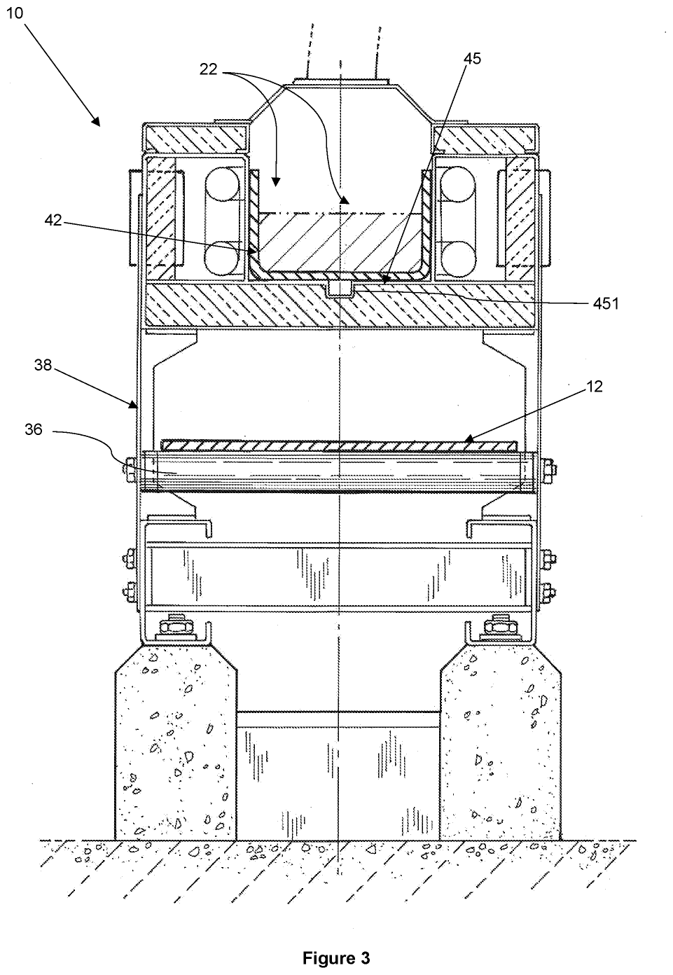

As shown in FIG. 3, the mould forming support 20 is mounted on a support indicated generally by numeral 38 and is stationary and has a smooth operatively upper surface 45 over which the conveyor 12 is displaced when it travels from the feed end 14 to the peel off end 16. The mould forming support 20 may be formed of steel and an upper surface thereof 45 facing the conveyor belt is typically smooth for assisting the belt 12 to slide across its surface 45. The mould forming support 20 may conveniently be referred to as a slip form box. In turn, the belt is typically made of a material having a low coefficient of friction, e.g. a vinyl polymer such as PVC.

FIG. 3 also shows the general support structure for the apparatus 10. It also shows clearly how the belt is deformed by the mould forming support 20 into the cross-sectional shape of the open channel mould 22. It also shows the flat belt on the return leg of the conveyor travelling back to the feed end underneath the open channel mould. FIG. 3 also show part of a heating arrangement for heating the settable material in the mould as will be described in more detail below.

The apparatus further includes a feed arrangement indicated generally by reference numeral 50 which is clearly shown in FIGS. 1, 2 and 4 for feeding a flowable settable material onto the belt 12 proximate the feed end 14. The feed arrangement 50 comprises a series of hoppers 52 containing the various components making up the settable cementitious material that is operatively connected to a mixing unit 54. The unit 54 draws the components from the series of different tanks 52 and mixes them together to form a flowable settable material. The feed arrangement 50 further includes a vibrating hopper 56 which vibrates the settable material and thereby encourages it to flow through the hopper 56 and onto the conveyor belt 12. Without the vibrations, the cementitious material may tend to hang up and block an outlet of the hopper 56 and cease the flow of feed material out of the hopper 56 onto the conveyor 12.

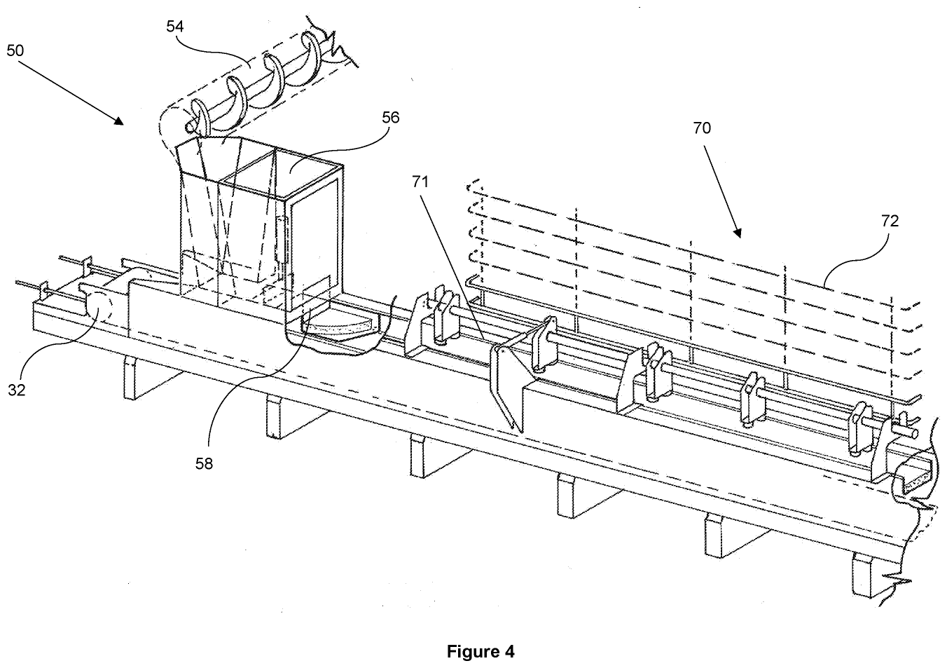

The feed arrangement 50 further includes a height setting arrangement indicated generally by numeral 58 and shown in FIG. 1 and FIG. 4 for enabling a user to set the height of the settable material in the open channel mould 22. That is, the height setting arrangement 58 is adjustable to enable the height of the settable material within the open channel mould 22 to be adjusted. It will be appreciated that the selected height of the settable material in the open channel mould is an important setting or parameter because it determines the thickness or depth of the solid cast member 30 produced by the apparatus 10.

The apparatus further includes a belt sliding arrangement 451 which uses pneumatic pressure, e.g. air under pressure, to reduce the effective weight of the belt and the settable material on the belt, that bears on the mould forming support 20. This makes it easier for the belt to slide across the mould forming support.

The belt sliding arrangement is shown most clearly in FIG. 3. In the illustrated embodiment, the belt sliding arrangement includes injecting air under pressure into a space between the operatively upper surface of the mould forming support and the conveyor belt. This provides some lift to the conveyor belt and reduces the effective weight of the conveyor and settable material on the mould forming support.

The apparatus 10 further includes a product divider insertion arrangement, indicated generally by numeral 60 which is shown in conceptual terms in FIG. 1, for inserting a solid product divider into the settable material that has been continuously fed onto the conveyor belt 12. In the illustrated embodiment, the product divider insertion arrangement 60 comprises a structure 62 positioned above the conveyor 12 downstream of the feed arrangement 50 that inserts the solid product divider into the settable material at spaced intervals as the cementitious material fed onto the conveyor belt 12 is continuously moved along the mould forming support 20. The product divider forms discontinuity or break in the cementitious material being cast on the conveyor belt 12 and this enables discrete cast cementitious products 30 to be formed by the apparatus 10 as required by the production schedule which in turn is determined by market needs. Otherwise a single continuous length of cast member 30 would be produced.

Optionally, the apparatus 10 further includes a reinforcing insertion arrangement 70 positioned downstream of the feed arrangement 50 and the product divider insertion arrangement 60. The arrangement 70 is shown most clearly in FIG. 4. The reinforcing insertion arrangement 70 comprises a structure 71 positioned overhead the conveyor belt 12 that grabs a reinforcing member 72, e.g. a steel reinforcing member, and lowers it into the settable material received within the open channel mould 22 formed by the conveyor 12. By appropriate agitation or vibration of the settable cementitious material, the reinforcing member 72 submerges itself into the body of cementitious material so that the reinforcing member 72 is fully received within the cast solid member 30 when formed. The steel reinforcing insertion arrangement 70 typically includes a lowering arm for lowering the reinforcing member 72 into the settable material.

The apparatus 10 also includes a plurality of heating arrangements for heating the settable cementitious material as it moves along the casting leg 31 of the conveyor belt 12. The heating arrangements, which are shown most clearly in FIGS. 1, 5 and 7 cure the cementitious material so that it forms a cast solid member 30 having sufficient strength to leave from the conveyor 12 and then be handled and transported for use.

In the illustrated embodiment, the apparatus 10 includes a radiant heating arrangement 80 for heating the settable material within the open channel mould to cure the material.

The radiant heating arrangement 80 includes a plurality of radiant or microwave heaters, e.g. in a line along the conveyor belt 12, e.g. directing microwaves at the settable material to cure the settable material.

The apparatus 10 also includes a conductive heating arrangement 84 including conductive heaters for heating sides of the conveyor belt 12 forming the open mould 22 which heat is then conducted through the conveyor belt 12 and into the settable material.

The apparatus 10 also includes an induction heating arrangement 86 positioned adjacent the open channel mould 22 for heating the steel reinforcing member 72 contained within the settable material by induction. Induction heating may be particularly useful in this context because it can heat the steel members 72 received within the body of cementitious material and thus heats the inside of the cementitious material. This can lead to advantageous curing of the cementitious material.

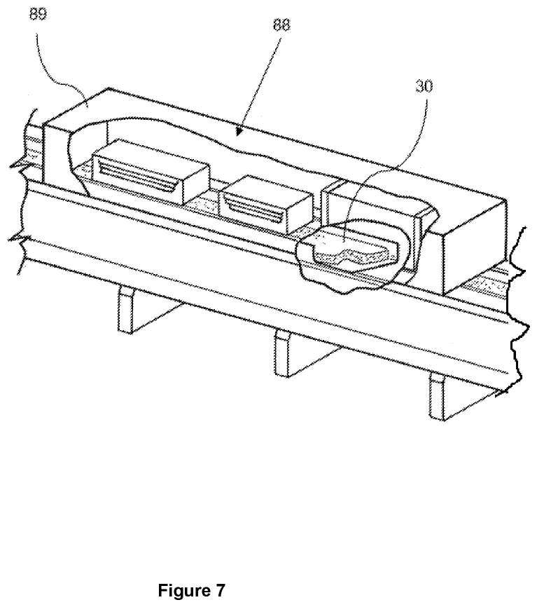

The apparatus 10 also includes a steam and air heating arrangement 88 for passing steam and/or hot air over the settable material for heating and curing the settable material. In the illustrated embodiment, the steam and air heating arrangement 88 is positioned downstream of the other heating arrangements 80, 84 and 86. As best seen in FIG. 7, the steam and air heating arrangement 88 includes a tunnel structure 89 extending over the conveyor belt 12 spaced above the belt for channelling steam and/or hot air to flow over the settable material in the open channel mould 22.

Advantageously, the settable material is heated to a temperature of up to about 50 degrees Celsius (° C.), including at least about 40, 42, 44, 46, and 48° C.; up to about 60° C., including at least about 52, 54, 56, and 58° C., or up to about 70° C., including at least about 62, 64, 66, and 68° C., to expedite curing of the settable material. It is typically desirable to cure the settable material as quickly as possible because this will reduce the residence time required for the settable material to be retained within the open channel mould 22 on the conveyor belt 12 before it can be peeled off the open channel mould 22. Steam can be particularly desirable for use as a heating material because the moisture within steam provides water which helps to resist and reduce cracking of the cementitious material and in particular, it helps to reduce surface cracks.

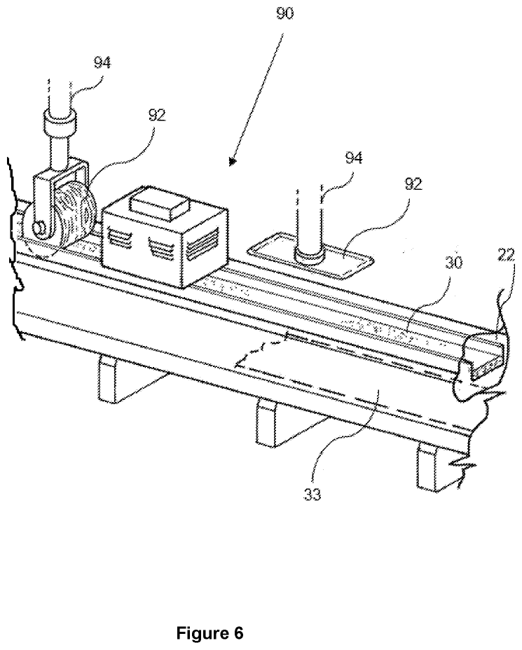

Optionally, the apparatus 10 may further include a surface finishing arrangement 90 for producing a certain surface appearance on the cast solid member 30. The surface finishing arrangement 90, which is shown most clearly in FIG. 6, typically includes a stamp 92 positioned above the conveyor belt 12 actuated by a ram or piston 94 for stamping a certain appearance into the open and upwardly facing surface of the cast solid member 30. In particular, the stamp 92 typically has a surface pattern that is then impressed in the surface of the settable material. Typically, these surface patterns are aesthetic and can contribute to the market value of products, such as retaining wall products or landscaping products. By way of non-limiting example, the stamp 92 might create the appearance of a wood grain in the surface of the product 30. The stamp 92 may be mounted on a gantry or overhead structure positioned above the conveyor belt 12 and may be displaced downwardly by the press or ram 94 into contact with the upper surface of the cast solid member 30 within the open channel mould 24.

For optimal functioning of the surface finishing arrangement 90, the solid member should be in an at least partially unset and/or uncured state. Depending on factors such as the particular settable material used and the particular heating arrangements included in the apparatus, the surface finishing arrangement may be positioned upstream or downstream of one or more of the heating arrangements such as heating arrangements 80-88 described herein.

As illustrated in FIGS. 1 and 8, the apparatus can include a further conveyor 100 (optionally called a curing conveyor) downstream of said one conveyor 12 (which may be referred to as a casting conveyor) extending from a feed end 102 to a discharge end 104.

This enables the cast solid member 30 to cure further before it is subjected to general handling including packing and stacking on pallets or the like. The further conveyor 100 comprises a series of spaced rollers 106 extending transverse to the direction of travel of the solid members 30 for conveying them along a conveyor path. The rollers 106 are caused to rotate in a direction that displaces the cast members 30 in a direction from the feed end 102 towards the discharge end 104. At this stage, the cast members 30 have sufficient strength to hold their form and support themselves on the further or curing conveyor 100 while they are cured further and acquire further structural strength. This enables the cast members 30 to become stronger before they are taken off the further conveyor 100 at the discharge end 104.

The further conveyor 100 may optionally have a further tunnel structure (not shown) associated therewith and steam and/or air and/or waste heat may be directed through the further tunnel structure to further heat the cast members 30. The further conveyor 100 optionally may use waste heat from the one or casting conveyor 12 and, in particular, from the steam heating arrangement indicated by numeral 88.

The apparatus 10 may further include a cast member handling arrangement 110 best shown in FIG. 8 for removing the solid cast members 30 from the production line as they are formed and then placing them in or on a storage or distribution member such as a pallet 112. An example of such a cast member handling arrangement 110 is shown schematically in the drawings and in particular in FIGS. 1 and 8. The arrangement 110 comprises an overhead lifting device 114 that can be displaced into a loading position above the further conveyor 100 where the cast member is positioned. The cast member 30 is attached to the lifting device 114 and then displaced to a storage or transport position where the cast member 30 is packed together with other cast members 30.

FIG. 14 shows another embodiment of an apparatus or system for continuously casting a solid member from a settable material, referred to herein as apparatus 11. The apparatus 11 is similar as described for the apparatus 10, comprising a flexible conveyor belt 12 having a feed end 14 and a peel off end 16 (not shown); a mould forming support 20; and a feed arrangement 50.

A notable difference between the apparatus 11 and the apparatus 10 is that the apparatus 11 comprises a significantly extended feed end transition section 40, forming an elongated lead up portion. The elongated lead up portion 40 facilitates alternative arrangements of the divider insertion arrangement 60 and the reinforcing insertion arrangement 70. In particular, in the apparatus 11, the divider insertion arrangement 60 and the reinforcing insertion arrangement 70 are positioned upstream of the feed arrangement 50, such that dividers 62 and insertions 72 (such as steel insertions) can be placed on the conveyer belt 12 prior to feeding flowable settable material onto conveyer belt 12.

As depicted in FIG. 14, the divider insertion arrangement 60 and the reinforcing insertion arrangement of the apparatus 11 are manual arrangements, wherein operators assist with positioning of the divider insertions and the reinforcing insertions. It will be readily understood, however, that automated or semi-automated arrangements may also be used. In particular, the insertions may be positioned using a gantry and lowering arm structure, or the like, such as structure 71 of apparatus 10, wherein the structure is positioned to lower insertions onto lead up portion 40 of apparatus 11.

It will be readily understood that the apparatus 11 may further comprise other components substantially as described for the apparatus 10, such as one or more heating arrangements 80-88, a surface finishing arrangement 90, a further or secondary conveyer belt 100, and/or a product handling arrangement 110.

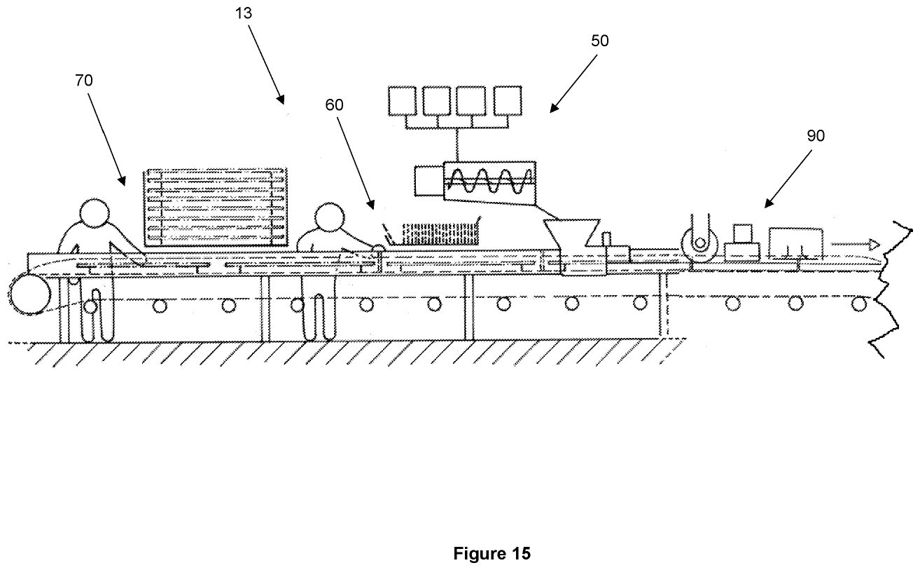

FIG. 15 shows another embodiment of an apparatus for continuously casting a solid member from a settable material, referred to herein as apparatus 13. Apparatus 13 is similar as described for apparatus 11. However, apparatus 13 includes a surface finishing arrangement 90. The surface finishing arrangement 90 of apparatus 13 comprises structure as described for apparatus 10. However, for apparatus 13, the surface finishing arrangement 90 is located directly, or substantially directly, downstream of the feed arrangement 50.

It will be appreciated that apparatus 13 facilitates impression onto the substantially wet settable material to produce a surface pattern for cast solid member 30. Typically, one or more heating arrangements are located downstream of the surface finishing arrangement 90 of apparatus 13, such that solid member 30 is set and cured using the heating arrangements in a similar manner as described for apparatus 10.

Typical use of the apparatus or systems as described herein will now be described.

In use, the apparatus 10, 11, and 13 described herein can be used for continuously and/or serially cast one or more cementitious members from a settable cementitious material.

The settable cementitious material is mixed in the feed arrangement 50 and is then fed onto the conveyor 12 in a controlled fashion. The conveyor 12 is formed up into the open channel mould 22 by the mould forming support 20 over which it travels. The settable cementitious material is fed into the open channel mould 22 up to a desired height corresponding to a desired thickness or depth of the concrete member 30 to be produced. Thereafter, the settable material moves with the conveyor belt 12 along the casting leg 31 from the feed end 14 to the peel off end 16.

For the apparatus 10, after the settable material has been fed into the open channel mould 22 in a controlled fashion, the steel 72 for reinforcing the cast concrete member 30 is inserted into the body of settable material which is in slurry form at that point. This is accomplished using the reinforcing insertion arrangement 70 as described above and illustrated in FIGS. 1 and 4 of the drawings.

For the apparatus 11 and 13, the steel 72 for reinforcing the cast concrete member and the dividers 62 for dividing individual cast concrete members are placed onto the conveyer belt 12 in the elongated lead up portion 40. Accordingly, the settable cementitious material is fed into the open channel mould 22 containing the steel 72 and dividers 62 by the feed arrangement 50.

The settable cementitious material may have its upper or exposed surface stamped by the surface finishing arrangement 90 at this point, such as shown in FIG. 6 and FIG. 15. This is used to impress or imprint a desirable aesthetic pattern or finish into the surface of the cast solid member 30.

Expedition of setting and curing of the cementitious material is accomplished by means of the heating arrangements 80 to 88. The conductive heating arrangement indicated by reference numeral 84 heats up sides and a base of the open channel mould 22 formed by the conveyor belt 12. The belt 12 in turn transfers this heat through to the cementitious material retained within the open channel mould 22.

Further, the radiation heating arrangement indicated generally by reference numeral 80 comprising a plurality of radiant or microwave heaters irradiates the settable material within the open channel mould 22 with microwaves. The microwaves cause excitation of the water molecules within the settable material that heats the material and promotes curing thereof. Yet further, the induction heating arrangement 86 heats the reinforcing steel 72 within the settable material by induction heating.

After the settable cementitious material is heated within the open channel mould 22 by these heating arrangements, the settable cementitious material is further cured by steam or air heating using the heating arrangement 88. This involves directing steam and/or hot air through the tunnel structure 89 over the settable material in the mould 22 to further cure the material. By this point, the settable material within the mould has acquired a solid form as the member 30 can hold its own shape even though it has not yet acquired its full mechanical strength.

In some cases, such as shown in FIG. 1, impression or stamping of the upper or exposed surface of the solid member 30 may occur after one or more of the heating or curing steps. However, the solid member should be in at least a partially unset and/or uncured state in order to impress or imprint a desirable aesthetic pattern or finish into the surface of the cast solid member 30.

Thereafter, the newly formed cast solid member 30 is separated from the open channel mould 22 within which it has been formed by a process known as ‘peel off’. This process is illustrated in considerable detail in FIG. 8. In ‘peel off’, the mould forming support 24 transitions from an open channel mould configuration to a flat surface configuration and the conveyor 12 containing the cast solid member follows this transition from open channel mould 22 to flat member 24. This transition, while the conveyor 12 is being displaced along the casting leg 31, progressively peels the cast solid member 30 off the underlying conveyor belt surface 24. Shortly or soon after this transition is completed, the conveyor belt 12 turns around the return roller 34 and completely separates from the cast solid member 30. This peel off step is an important step in the continuous casting process because it occurs very smoothly and is very gentle on the cast solid member 30. As a result, there is typically little or no damage to the member 30 and consequent little waste caused by this step of the process.

The cast solid members 30 passing off the end 16 of the conveyor belt 12 may be fed onto a further or secondary conveyor belt 100 where they are further cured and strengthened before they are lifted off the belt 100 by the product handling arrangement 110 and packed onto a pallet for shipping. The cast solid members 30 are further heated by steam and/or hot air and/or waste heat on the further conveyor 100 which further cures them to the point where they have sufficient mechanical strength for their final handling and packaging.

Concrete members are typically a structural component. They are designed to withstand and transfer heavy loads under compression and/or tension and may include columns and beams. This is to be contrasted with boards forming drywall or plasterboard that form a non-structural finishing material. These boards are often made of gypsum and create flat smooth surfaces for interior walls and ceilings of a building and do not carry a structural weight.

Concrete is composed of three main physical components, aggregates, binder and water.

The aggregate comprises filler: coarse (gravel, crushed stone) and fine (sand) that are largely inert and make up the bulk (70-80%) of the material. The binder comprises cement usually being Portland cement, which chemically reacts with water to form the binding paste. When cement is mixed with water, a process called hydration occurs, which is a series of exothermic chemical reactions. These reactions produce the crystalline and amorphous compounds that bind the aggregates together into a solid, strong mass. Thus, concrete is a composite material which derives its strength from the chemical reaction of its binder which is typically Portland cement with water.

In the embodiment described above, the cementitious material may, for example, comprise Portland cement as the binder that is mixed in with the aggregate and undergoes a chemical reaction such as hydration to cure the cementitious material.

In another embodiment, the curing may be assisted by or carried out by chemical curing of the cementitious material. Chemically curing the settable cementitious material may comprise curing with Calcium aluminate. Calcium aluminate is known as a binder that can be used in cementitious materials. Applicant has found that the addition of calcium aluminate speeds up the curing process and a high strength of the solid concrete member can be achieved early.

Optionally, the settable cementitious material that is used to form the solid concrete member may contain 0-20 weight % of calcium aluminate. This has been found to meaningfully reduce the curing time without detracting from other properties of the concrete member. As the use of calcium aluminate as a binder in cementitious materials is known in the art of making cement. it will not be described further in the detailed description.

Additionally, the settable cementitious material may be chemically cured by using at least some siliceous or silico-aluminous materials. The Applicant has also used silico-aluminate-based cementitious materials utilizing pozzolanic waste and low-grade materials.

Silicon dioxide (SiO₂) is a crucial component of cement that contributes to its strength by forming calcium silicates during the hydration process. It is also present in aggregates like sand, which is used to make concrete. A cementitious material can be enhanced by adding pozzolanic materials like silica to improve the properties of the formed concrete member. Further, the addition of silico-aluminate may also help to expedite the curing of settable cementitious material on the conveyor.

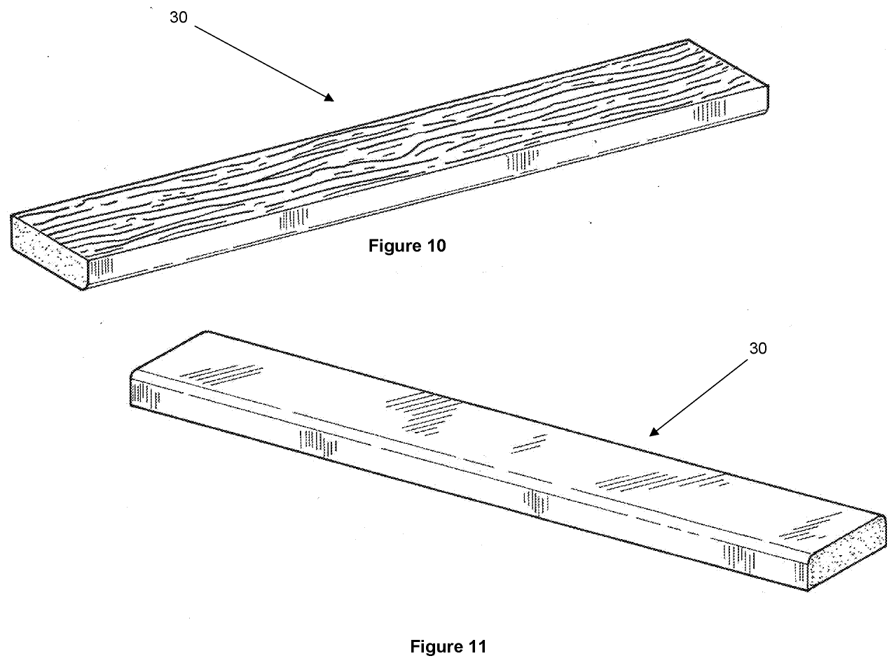

FIGS. 10 and 11 illustrate some non-limiting examples of cast solid members produced by the process described above. These cast members 30 may conveniently be used as concrete sleepers for retaining walls and the like. The member 30 in FIG. 10 has a back surface (which corresponds to the upper, open and exposed surface in the open channel mould 22) which has been stamped to have a wood grain type appearance. The member 30 in FIG. 11 has been produced with a smooth back surface which may be preferred to the wood grain in some uses and applications.

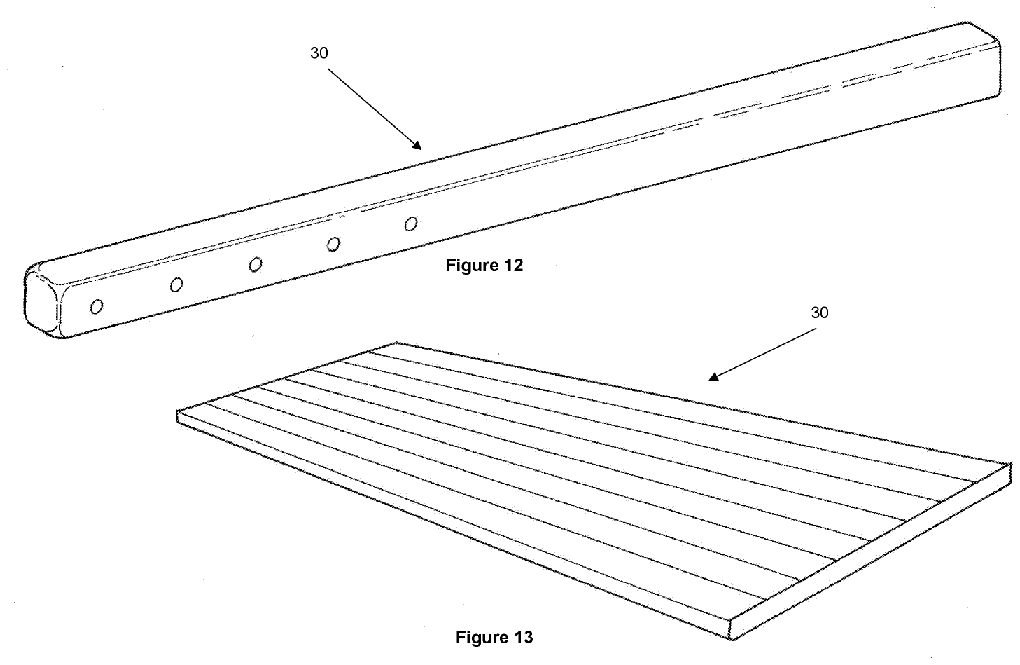

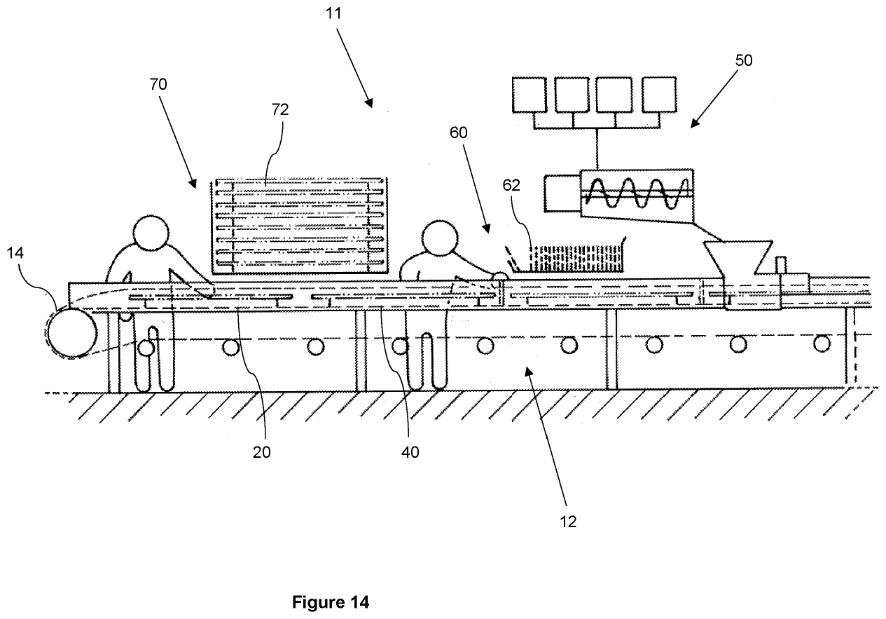

FIGS. 12 and 13 illustrate some further non-limiting examples of cast solid products producing by an apparatus and method similar to that described above with reference to the figures.

FIG. 12 is a post like member having a width than is comparable to its depth. The member 30 in FIG. 11 resembles a post having apertures spaced along its length.

FIG. 13 is a panel like member having a substantially greater width. The member 30 in FIG. 13 is more like a flat panel having a width that is significantly greater than its depth or height and that is much wider than the member 30 in FIG. 10 and FIG. 11. This member could, for example, be used to form a wall panel or the like. The wider product is achieved in an apparatus similar to that shown in the figures by having a different configuration of mould forming support 20, e.g. a wider support 20, which in turn deforms the belt 12 into a configuration corresponding to the panel, e.g. wall panel, to be produced.

One important advantage of the method and apparatus described above with reference to the drawings is that it can provide a continuous process for casting cementitious or concrete members. The concrete is feed onto one end of a conveyor belt and the formed cast product is removed from the other end of the process and there is no individual handling of the concrete member or the mould carrying the cementitious material in the process. This can greatly simplifies the process and reduces the amount of labour required in the process and it also reduces the amount and extent of machinery and equipment to carry out the process.

In the illustrated embodiments, the Applicant has been able to devise an effective technique to deform a conveyor belt up into an open channel that forms a mould for the settable material and the material is cured as it passes along the length of the conveyor belt. The Applicant has also devised an effective technique for peeling the formed cast member off the mould formed by the conveyor belt at the end of the conveyor belt. Essentially, the Applicant transitions the conveyor belt from the open channel mould back to a flat conveyor surface and then turns the conveyor around a return roller of the conveyor and this effectively peels the cast product off the belt.

Further, the Applicant is able to engineer the height or depth of the cementitious material within the open channel of the conveyor belt and thereby engineer the thickness or depth of the cast member that is produced. This is useful because this can be done using the same mould simply by changing a process setting. It does not require a different apparatus.

Yet another working advantage of the embodiments described above with reference to the drawings is that the open channel mould 22 has walls that are orthogonal to a base of the mould 22. The walls of the mould are rectilinear and do not require the side walls to taper out from the base to the upper ends of the side walls. This makes it easier to produce a product of consistent size, and also the cast member is easier to work with if it has square sides. By contrast, the prior art batch techniques do require the side walls to be tapered.

In this specification, the term “batch process” shall be understood to mean a process in which a member is cast by being placed in a discrete and individual mould having a mould cavity with the same configuration as the product to be produced and then cured in that mould until it has set, and thereafter it is broken out of the mould as a formed cast product.

In this specification, the term “continuous casting process” shall be understood to mean a process in which flowable cementitious material can be substantially continuously fed into one end of a process and displaced along a process path and wherein the formed product can be substantially continuously or serially withdrawn from the process.

In the present disclosure and claims, the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

In this specification, the use of the terms “suitable” and “suitably”, and similar terms, is not to be read as implying that a feature or step is essential, although such features or steps referred to as “suitable” may well be preferred.

It is intended that all matter contained in the above description or shown in the accompanying drawings shall be interpreted as illustrative only and not limiting. All such modifications and variations thereto, as would be apparent to persons skilled in the art, are deemed to fall within the broad scope and ambit of the invention as is set forth herein. Changes in detail or structure may be made without departing from the basic elements of the invention as defined in the following claims.

1. A method for continuously casting a solid concrete member from a settable cementitious material that forms concrete when cured, comprising:
providing a conveyor having a feed end and a peel off end, the conveyor comprising a flexible conveyor belt that is displaced in a conveying direction from the feed end to the peel off end,
deforming the conveyor belt so that it is configured in the form of an open channel mould near the feed end and travels in the conveying direction, the open channel mould comprising substantially vertical side walls and a substantially horizontal bottom wall,
feeding the settable cementitious material into the open channel mould and displacing the settable cementitious material along the conveyor to the peel off end,
curing the settable cementitious material during displacement along the conveyor so that the cementitious material forms at least part of an elongate solid concrete member before it reaches the peel off end, and
separating the formed solid concrete member from the open channel mould by deforming the conveyor belt to separate the vertical side walls from the solid member and changing the angle or orientation of the conveyor belt at the peel off end to separate the bottom wall from the solid member.

2. The method for continuously casting a solid concrete member according to claim 1, wherein deforming the conveyor belt from the open channel mould to separate the vertical side walls from the solid member comprises forming the conveyor belt into a substantially flat configuration.

3. The method for continuously casting a solid concrete member according to claim 1, wherein changing the angle or orientation of the conveyor belt at the peel off end to separate the bottom wall from the solid member may comprise changing the direction of the conveyor belt.

4. The method for continuously casting a solid concrete member of claim 3, wherein the conveyor comprises a return roller at the peel off end and said changing the direction of the conveyor belt at the peel off end comprises passing the conveyor belt over the return roller.

5. The method for continuously casting a solid concrete member of claim 1, wherein said curing comprises heating the settable cementitious material while it is being displaced along the conveyor towards the peel off end.

6. The method for continuously casting a solid concrete member of claim 5, wherein said heating comprises one or more of: radiation heating, convection heating, and conductive heating; and the settable cementitious material is heated to a temperature of at least 40 degrees Celsius.

7. The method for continuously casting a solid concrete member of claim 1, wherein said curing comprises chemically curing the settable cementitious material while it is being displaced along the conveyor.

8. The method for continuously casting a solid concrete member of claim 7, wherein said chemical curing of the settable cementitious material comprises curing with a calcium aluminate or a siliceous or silico-aluminous material.

9. The method for continuously casting a solid concrete member of claim 1, wherein the settable cementitious material comprises 10-20 weight % of calcium aluminate.

10. The method for continuously casting a solid concrete member of claim 6, wherein said curing comprises heating said settable cementitious material in addition to chemically curing said cementitious material.

11. The method for continuously casting a solid concrete member of claim 1, wherein the open channel mould is formed with a substantially constant cross-sectional configuration along its length.

12. The method for continuously casting a solid concrete member of claim 1, further comprising dividing the settable cementitious material on the conveyor into discrete elements on the conveyor to form separate solid concrete members by at least one of: lowering dividers into the settable cementitious material before it cures; and placing dividers upstream of a position where the settable cementitious material is fed into the open channel mould to divide the open channel mould into lengthwise sections.

13. The method for continuously casting a solid concrete member of claim 1, further comprising inserting a reinforcing member into the settable cementitious material in the open channel mould before it cures whereby to provide reinforcing in the solid concrete member.

14. An apparatus for casting a solid concrete member from a settable cementitious material that cured to form concrete, the apparatus comprising:
a conveyor having a feed end and a peel off end, the conveyor comprising a flexible conveyor belt that is displaced in a conveying direction from the feed end to the peel off end; and
a feeder for feeding a flowable settable material onto the conveyor,
wherein the conveyor belt is deformed into a main casting section forming an open channel mould of substantially constant cross sectional configuration with substantially vertical side walls and a substantially horizontal bottom wall, and the conveyor belt is formed into a peel off transition section towards the peel off end which is different from the open channel mould to separate the conveyor belt from a solid concrete member formed on the conveyor.

15. The apparatus of claim 14, wherein the peel off transition section deforms the conveyor belt into a substantially flattened configuration to separate the vertical side walls of the open channel mould from a formed solid concrete member.

16. The apparatus of claim 14, wherein the conveyor comprises a return roller at the peel off end and the belt is bent around the return roller to separate the bottom wall of the open channel mould from a formed solid concrete member.

17. The apparatus of claim 14, including at least one heater for heating the settable material within the open channel mould for curing the settable material to form the solid member, wherein the at least one heater comprises at least one heater type selected from the group comprising: one or more radiant heaters; one or more conductive heaters; and/or one or more convection heaters displacing steam or hot air over the settable material in the open channel mould.

18. The apparatus of claim 14, comprising a feed transition section towards the feed end which transitions the conveyor belt into the main casting section, and wherein the feeder is configured to feed a flowable settable material onto the conveyer comprising a mixing unit for drawing components from separate tanks and mixing the to form the settable cementitious material in the form of a flowable slurry.

19. The apparatus of claim 14, comprising a height setter comprising a height setting member positioned downstream of the feeder that enables the height of the settable material in the open channel mould to be adjusted whereby to set the thickness of the solid concrete member produced by the open channel mould.

20. The apparatus of claim 14, comprising a product divider inserter for inserting a divider into the settable material fed onto the conveyor to divide it into discrete solid members and/or a reinforcing inserter for inserting a reinforcing element into the settable material to provide reinforcing in the formed solid member.
